(19) United States
(12) Patent Application Publication
(10) Pub. No.: US 2006/0111501 A1
(43) Pub. Date: May 25, 2006

(54) Thermoplastic wear resistant compositions, methods of manufacture thereof and articles containing the same

(75) Inventors: Nicola Cont, Bergen op Zoom (NL); Hua (Lotus) Huang, Shanghai (CN)

Correspondence Address: GEAM - LNP-CE 08CE;IP LEGAL, ONE PLASTICS AVENUE, PITTSFIELD, MA, 01201-3697, US

(73) Assignee: General Electric Company

(21) Appl. No.: 11/175,241

(22) Filed: Jul. 6, 2005

Related U.S. Application Data
(60) Provisional application No. 60/629,439, filed on Nov. 19, 2004.

(51) Int. Cl. B60C 1/00; C08K 3/04

(52) U.S. Cl. 524/492; 524/495

(57) ABSTRACT

Disclosed herein is a composition comprising a polycarbonate resin; a polycarbonate-polysiloxane copolymer; and an anhydride modified polyolefin. Disclosed herein too is a composition comprising a blend of a polycarbonate resin with a polycarbonate-polysiloxane copolymer; and an anhydride modified polyethylene, wherein the composition has a wear factor of less than or equal to about 350 in⁵min/ftlb-hr and an impact strength of greater than or equal to about 500 joules per meter, and wherein the wear factor is measured according to the formula:
Wear Factor=[(6.1×10⁸)(W)][(P×V)×(D)×(T)] where P is the applied pressure in pounds per square inch and V is the velocity in feet per minute, W is the weight loss in grams, D is the density in grams per cubic centimeter and T represents 100 hours.

### CROSS REFERENCE TO RELATED APPLICATION

This application claims the benefit of U.S. Provisional Application Ser. No. 60/629439, filed Nov. 19, 2004.

### BACKGROUND

This disclosure relates to thermoplastic wear resistant compositions, methods of manufacture thereof and articles containing the same.

Machine components that are subjected to frictional forces generally use external lubricants, such as oil or grease, to increase the wear resistance and reduce frictional losses. However, such external lubricants often must be replaced periodically and may be unevenly distributed over the wear surface, resulting in increased cost and inefficiency of the machine components. In addition, external lubricants are often not desirable, for example, in the areas of food processing or photocopying where product contamination is a concern.

The need for external lubricants may be reduced or eliminated by the use of polymeric machine components that contact each other. Polymeric components may be easily and inexpensively manufactured by such processes as injection molding to form intricately shaped components such as gears, cams, bearings, slides, ratchets, pumps, electrical contacts and prostheses.

Polymeric contacting components provide an economical and essentially maintenance free alternative to metallic or ceramic contacting components. Components formed from polymeric compounds have reduced weight, enhanced corrosion protection, decreased running noise, decreased maintenance and power use, and allow increased freedom of component design over non-polymeric components. Internal lubricants, such as polytetrafluoroethylene, graphite, molybdenum disulfide, and various oils and reinforcing fibers may be included in polymeric components to enhance wear resistance and decrease frictional losses. However, such internal lubricants are costly and increase the complexity and number of processing steps. In addition, polymeric contacting components often undergo physical ageing with time and fracture because of an inability to withstand impact forces encountered during operation. It is therefore desirable to have polymeric contacting components which are wear resistant, impact resistant and which are easy to manufacture using existing equipment.

### SUMMARY

Disclosed herein is a composition comprising a polycarbonate resin; a polycarbonate-polysiloxane copolymer; and an anhydride modified polyolefin.

Disclosed herein too is a composition comprising a blend of a polycarbonate resin with a polycarbonate-polysiloxane copolymer; and an anhydride modified polyethylene, wherein the composition has a wear factor of less than or equal to about 350 in⁵min/ftlb-hr and an impact strength of greater than or equal to about 500 joules per meter and wherein the wear factor is measured according to the formula:
Wear Factor=[(6.1×10⁸)(W)]/[(P×V)×(D)×(T)]
where P is the applied pressure in pounds per square inch and V is the velocity in feet per minute, W is the weight loss in grams, D is the density in grams per cubic centimeter and T represents 100 hours.

Disclosed herein too is a method comprising blending a polycarbonate resin, a polycarbonate-polysiloxane copolymer, and an anhydride modified polyolefin to form a thermoplastic composition, wherein a blend of the polycarbonate resin and the polycarbonate-polysiloxane copolymer is either optically transparent or opaque.

### DETAILED DESCRIPTION OF EMBODIMENTS

It is to be noted that as used herein, the terms “first,” “second,” and the like do not denote any order or importance, but rather are used to distinguish one element from another, and the terms “the”, “a” and “an” do not denote a limitation of quantity, but rather denote the presence of at least one of the referenced item. Furthermore, all ranges disclosed herein are inclusive of the endpoints and independently combinable.

Disclosed herein is a wear resistant thermoplastic composition that comprises a mixture of a polycarbonate, a polycarbonate-polysiloxane copolymer and an anhydride-modified polyolefin. The thermoplastic compositions display a high impact strength and have higher crack propagation resistance over existing wear resistant compositions. Articles manufactured from the thermoplastic composition advantageously display impact strengths of greater than or equal to about 500 joules/meter at a temperature of −30° C. and a wear resistance factor K of less than or equal to about 350 in⁵min/ftlb-hr at room temperature. The thermoplastic compositions can be advantageously used in a variety of high temperature applications where large loads are applied.

The term “mixture” as described herein refers to the combination of polycarbonate, polycarbonate-polysiloxane copolymers and modified polyolefins. The term blend as described herein refers to the combination of polycarbonate with polycarbonate-polysiloxane copolymers.

As used herein, the terms “polycarbonate”, includes compositions having structural units of the formula (I): 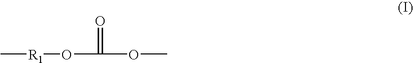
in which greater than or equal to about 60 percent of the total number of R₁ groups are aromatic organic radicals and the balance thereof are aliphatic, alicyclic, or aromatic radicals. In one embodiment, R₁ is an aromatic organic radical of the formula (II):
-A₁-Y₁-A₂- (II)
wherein each of A₁ and A₂ is a monocyclic divalent aryl radical and Y₁, is a bridging radical having zero, one, or two atoms which separate A₁ from A₂. In an exemplary embodiment, one atom separates A₁ from A₂. Illustrative examples of the Y₁ radicals are —O—, —S—, —S(O)—, —S(O)₂—, —C(O)—, methylene, cyclohexyl-methylene, 2-[2,2,1]-bicycloheptylidene, ethylidene, isopropylidene, neopentylidene, cyclohexylidene, cyclopentadecylidene, cyclododecylidene, adamantylidene, or the like. In another embodiment, zero atoms separate A₁ from A₂, with an illustrative example being biphenyl. The bridging radical Y₁, can be a saturated hydrocarbon group such as methylene, cyclohexylidene or isopropylidene.

Polycarbonates may be produced by the Schotten-Bauman interfacial reaction of a carbonate precursor with dihydroxy compounds. Typically, an aqueous base such as sodium hydroxide, potassium hydroxide, calcium hydroxide, or the like, is mixed with an organic, water immiscible solvent such as benzene, toluene, carbon disulfide, chloro-benzene, chloroform or dichloromethane, which contains the dihydroxy compound. A phase transfer agent is generally used to facilitate the reaction. As carbonate precursor carbonyl halides are employed. An exemplary carbonyl halide is carbonyl chloride (phosgene). Molecular weight regulators may be added either singly or in admixture to the reactant mixture. Branching agents, described forthwith may also be added singly or in admixture.

Polycarbonates can be produced by the interfacial reaction of dihydroxy compounds in which only one atom separates A₁ and A₂. As used herein, the term “dihydroxy compound” includes, for example, bisphenol compounds having general formula (III) as follows: 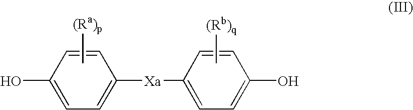
wherein R^{a} and R^{b} each independently represent hydrogen, a halogen atom, or a monovalent hydrocarbon group, p and q are each independently integers from 0 to 4, and X^{a} represents one of the groups of formula (IV): 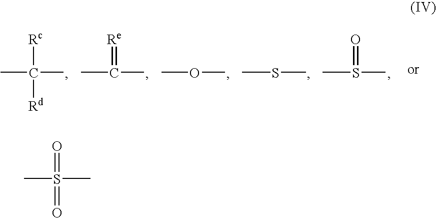
wherein R^{c} and R^{d} each independently represent a hydrogen atom or a monovalent linear or cyclic hydrocarbon group, and R^{e} is a divalent hydrocarbon group, oxygen, or sulfur.

Examples of the types of bisphenol compounds that may be represented by formula (III) include the bis(hydroxyaryl)alkane series such as, 1,1-bis(4-hydroxyphenyl)methane, 1,1-bis(4-hydroxyphenyl)ethane, 2,2-bis(4-hydroxyphenyl)propane (or bisphenol-A), 2,2-bis(4-hydroxyphenyl)butane, 2,2-bis(4-hydroxyphenyl)octane, 1,1-bis(4-hydroxyphenyl)propane, 1,1-bis(4-hydroxyphenyl)n-butane, bis(4-hydroxyphenyl)phenylmethane, 2,2-bis(4-hydroxy-1-methylphenyl)propane, 1,1-bis(4-hydroxy-t-butylphenyl)propane, 2,2-bis(4-hydroxy-3-bromophenyl)propane, or the like; bis(hydroxyaryl)cycloalkane series such as, 1,1-bis(4-hydroxyphenyl)cyclopentane, 1,1-bis(4-hydroxyphenyl)cyclohexane, or the like, or combinations comprising at least one of the foregoing bisphenol compounds.

Other bisphenol compounds that may be represented by formula (III) include those where X is —O—, —S—, —SO— or —S(O)₂—. Some examples of such bisphenol compounds are bis(hydroxyaryl)ethers such as 4,4′-dihydroxy diphenylether, 4,4′-dihydroxy-3,3′-dimethylphenyl ether, or the like; bis(hydroxy diaryl)sulfides, such as 4,4′-dihydroxy diphenyl sulfide, 4,4′-dihydroxy-3,3′-dimethyl diphenyl sulfide, or the like; bis(hydroxy diaryl) sulfoxides, such as, 4,4′-dihydroxy diphenyl sulfoxides, 4,4′-dihydroxy-3,3′-dimethyl diphenyl sulfoxides, or the like; bis(hydroxy diaryl)sulfones, such as 4,4′-dihydroxy diphenyl sulfone, 4,4′-dihydroxy-3,3′-dimethyl diphenyl sulfone, or the like; or combinations comprising at least one of the foregoing bisphenol compounds.

Other bisphenol compounds that may be utilized in the polycondensation of polycarbonate are represented by the formula (V) 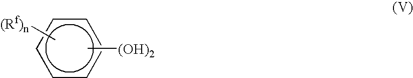
wherein, R^{f}, is a halogen atom or a hydrocarbon group having 1 to 10 carbon atoms or a halogen substituted hydrocarbon group; n is a value from 0 to 4. When n is at least 2, R^{f} may be the same or different. Examples of bisphenol compounds that may be represented by the formula (V), are resorcinol, substituted resorcinol compounds such as 5-methyl resorcin, 5-ethyl resorcin, 5-propyl resorcin, 5-butyl resorcin, 5-t-butyl resorcin, 5-phenyl resorcin, 5-cumyl resorcin, or the like; catechol, hydroquinone, substituted hydroquinones, such as 3-methyl hydroquinone, 3-ethyl hydroquinone, 3-propyl hydroquinone, 3-butyl hydroquinone, 3-t-butyl hydroquinone, 3-phenyl hydroquinone, 3-cumyl hydroquinone, or the like; or combinations comprising at least one of the foregoing bisphenol compounds.

Bisphenol compounds such as 2,2,2′,2′-tetrahydro-3,3,3′,3′-tetramethyl-1,1′-spirobi-[IH-indene]-6,6′-diol represented by the following formula (VI) may also be used.

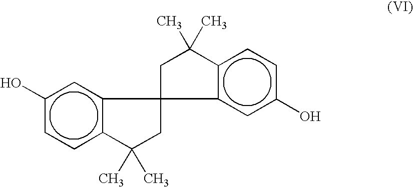

Suitable polycarbonates further include those derived from bisphenols containing alkyl cyclohexane units. Such polycarbonates have structural units corresponding to the formula (VII) 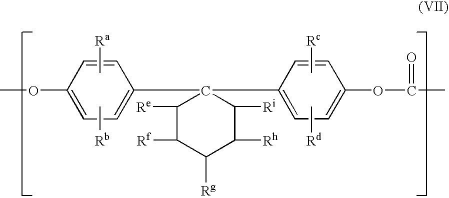
wherein R^{a}—R^{d} in the formula (VII) are each independently hydrogen, C₁-C₁₂ hydrocarbyl, or halogen; and R^{e}—Rⁱ in the formula (VII) are each independently hydrogen, C¹-C₁₂ hydrocarbyl. As used herein, “hydrocarbyl” refers to a residue that contains only carbon and hydrogen. The residue may be aliphatic or aromatic, straight-chain, cyclic, bicyclic, branched, saturated, or unsaturated. The hydrocarbyl residue may contain heteroatoms over and above the carbon and hydrogen members of the substituent residue. Thus, when specifically noted as containing such heteroatoms, the hydrocarbyl residue may also contain carbonyl groups, amino groups, hydroxyl groups, or the like, or it may contain heteroatoms within the backbone of the hydrocarbyl residue. Alkyl cyclohexane containing bisphenols, for example the reaction product of two moles of a phenol with one mole of a hydrogenated isophorone, are useful for making polycarbonate polymer s with high glass transition temperatures and high heat distortion temperatures. Such isophorone bisphenol-containing polycarbonates have structural units corresponding to the formula (VIII) 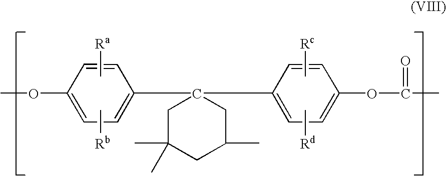
wherein R^{a}—R^{d} are as defined above in the formula (VII). These isophorone bisphenol based polymers, including polycarbonate copolymers containing nonalkylcyclohexane bisphenols and blends of alkyl cyclohexyl bisphenol containing polycarbonates with nonalkyl-cyclohexyl bisphenol polycarbonates, are supplied by Bayer Co. under the APEC trade name. An exemplary bisphenol compound is bisphenol A.

Examples of suitable carbonate precursors include the carbonyl halides, for example carbonyl chloride (phosgene), and carbonyl bromide; the bis-haloformates, for example the bis-haloformates of dihydroxy compounds such as bisphenol A, hydroquinone, or the like, and the bis-haloformates of glycols such as ethylene glycol and neopentyl glycol; and the diaryl carbonates, such as diphenyl carbonate, di(tolyl) carbonate, and di(naphthyl) carbonate. An exemplary carbonate precursor for the interfacial reaction is carbonyl chloride.

It is also possible to employ polycarbonates resulting from the polymerization of two or more different dihydric phenols or a copolymer of a dihydric phenol with a glycol or with a hydroxy- or acid-terminated polyester or with a dibasic acid or with a hydroxy acid or with an aliphatic diacid in the event a carbonate copolymer rather than a homopolymer is desired for use. Generally, useful aliphatic diacids have about 2 to about 40 carbons. An exemplary aliphatic diacid is dodecanedioic acid.

Branched polycarbonates, as well as blends of linear polycarbonate and a branched polycarbonate may also be used in the composition. The branched polycarbonates may be prepared by adding a branching agent during polymerization. These branching agents may comprise polyfunctional organic compounds containing at least three functional groups, which may be hydroxyl, carboxyl, carboxylic anhydride, haloformyl, and combinations comprising at least one of the foregoing branching agents. Specific examples include trimellitic acid, trimellitic anhydride, trimellitic trichloride, tris-p-hydroxy phenyl ethane, isatin-bis-phenol, tris-phenol TC (1,3,5-tris((p-hydroxyphenyl)isopropyl)benzene), tris-phenol PA (4(4(1,1-bis(p-hydroxyphenyl)-ethyl) α,α-dimethyl benzyl)phenol), 4-chloroformyl phthalic anhydride, trimesic acid, benzophenone tetracarboxylic acid, or the like, or combinations comprising at least one of the foregoing branching agents. The branching agents may be added at a level of about 0.05 to about 4.0 weight percent (wt %), based upon the total weight of the polycarbonate in a given layer.

In one embodiment, the polycarbonate may be produced by a melt polycondensation reaction between a dihydroxy compound and a carbonic acid diester. Examples of the carbonic acid diesters that may be utilized to produce the polycarbonates are diphenyl carbonate, bis(2,4-dichlorophenyl)carbonate, bis(2,4,6-trichlorophenyl) carbonate, bis(2-cyanophenyl) carbonate, bis(o-nitrophenyl) carbonate, ditolyl carbonate, m-cresyl carbonate, dinaphtlyl carbonate, bis(diphenyl) carbonate, diethyl carbonate, dimethyl carbonate, dibutyl carbonate, dicyclohexyl carbonate, bis(o-methoxycarbonylphenyl)carbonate, bis(o-ethoxycarbonylphenyl)carbonate, bis(o-propoxycarbonylphenyl)carbonate, bis-ortho methoxy phenyl carbonate, bis(o-butoxycarbonylphenyl)carbonate, bis(isobutoxycarbonylphenyl)carbonate, o-methoxycarbonylphenyl-o-ethoxycarbonylphenylcarbonate, bis o-(tert-butoxycarbonylphenyl)carbonate, o-ethylphenyl-o-methoxycarbonylphenyl carbonate, p-(tertbutylphenyl)-o-(tert-butoxycarbonylphenyl)carbonate, bis-(ethyl salicyl) carbonate (this is bis(o-ethoxycarbonylphenyl)carbonate etc), bis(-propyl salicyl) carbonate, bis-butyl salicyl carbonate, bis-benzyl salicyl carbonate, bis-methyl 4-chlorosalicyl carbonate or the like, or combinations comprising at least one of the foregoing carbonic acid diesters. An exemplary carbonic acid diester is diphenyl carbonate or bis(methyl salicyl) carbonate (BMSC).

The weight average molecular weight of the polycarbonate is about 3,000 to about 1,000,000 grams/mole (g/mole). In one embodiment, the polycarbonate has a molecular weight of about 10,000 to about 100,000 g/mole. In another embodiment, the polycarbonate has a molecular weight of about 15,000 to about 50,000 g/mole. In yet another embodiment, the polycarbonate has a molecular weight of about 18,000 to about 40,000 g/mole.

The polycarbonate polysiloxane copolymers can be block copolymers, random copolymers, star block copolymers or alternating copolymers. Exemplary polycarbonate polysiloxane copolymers are block copolymers. The polycarbonate-polysiloxane block copolymers comprise polycarbonate blocks having recurring units represented by the formula (IX): 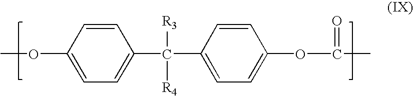
where R₃ and R₄ are each independently selected from hydrogen, hydrocarbyl or halogen-substituted hydrocarbyl and polysiloxane blocks represented by the formula (X): 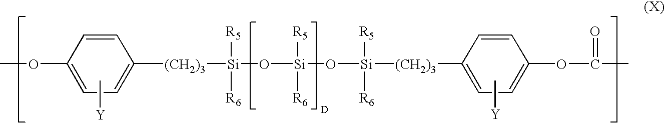
where R₅ and R₆ are each independently hydrogen, hydrocarbyl or halogen-substituted hydrocarbyl, D is an integer of from about 10 to about 120, and Y is hydrogen, hydrocarbyl, hydrocarboloxy or halogen. In one embodiment, the weight percent of blocks of formula (IX) is from about 10 to about 96% of the copolymer and the weight percentage of polysiloxane from the blocks of formula (X) is about 4 to about 90%.

In one exemplary embodiment, R₃ and R₄ in the formula (IX) are methyl groups, while R₅ and R₆ in formula (X) are methyl groups, D is an integer of about 40 to about 60, while Y is methoxy.

The block copolymers are prepared by the reaction of a carbonate forming precursor with a mixture of an aromatic dihydroxy compound of the formula (XI): 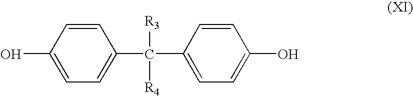
where R₃ and R₄ are as defined above; and a polysiloxane diol of the structure depicted by the formula (XII): 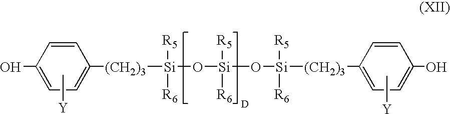
where R₅, R₆, Y and D are as defined above.

The polysiloxane diols depicted in formula (IV) above as precursors of the siloxane block may be characterized as bisphenolsiloxanes. The preparation of these bisphenolsiloxanes is accomplished by the addition of a polydiorganosiloxane (V) to a phenol (VI) containing an alkenyl substituent, according to the reaction: 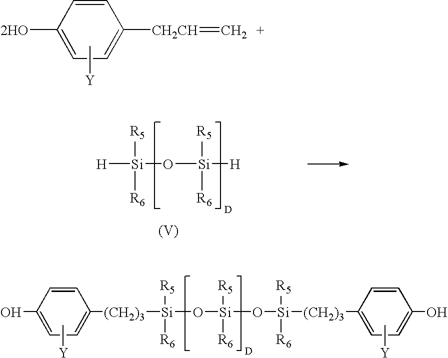
wherein R₅, R₆, Y and D are as defined above

In one embodiment, the polysiloxane diols of formula IV can be prepared by reacting a hydrogen-terminated polydimethylsiloxane with an allylphenol in the presence of a catalytic amount of chloroplatinic acid-alcohol complex at about 90° to about 115° C. Exemplary polysiloxane blocks can also be prepared by addition of a hydrogen-terminated polysiloxane to two molar equivalents of eugenol (4-allyl-2-methoxyphenol) in a reaction catalyzed by platinum or its compounds. The conversion of the bisphenolpolysiloxane (IV) and the bisphenol (III) to the block copolymer may be conducted by interfacial polymerization processes for making polycarbonates.

Although processes for manufacturing the copolymer may vary, an exemplary process involves dissolving or dispersing the reactants in a suitable water immiscible solvent medium and contacting the reactants with the carbonate precursor in the presence of a phase transfer catalyst, such as a tertiary amine co-catalyst and an aqueous caustic solution under controlled pH conditions. An exemplary process comprises a phosgenation reaction where the carbonate precursor is phosgene. The temperature at which the phosgenation reaction proceeds may vary from about 0° C. to about 100° C. Since the reaction is exothermic, the rate of phosgene addition may be used to control the reaction temperature. Sufficient alkali metal hydroxide base can be utilized to raise and maintain the pH of the mixture. The base is added in an amount effective to maintain the pH of the aqueous part of the reaction mixture in an amount of about 10 to about 12. The pH of the aqueous phase of the reaction mixture may also be controlled by the gradual addition of caustic such as sodium hydroxide, using an automatic pH controller.

A molecular weight regulator, i.e., a “chain stopper”, may be added to the reactants prior to or during the contacting of them with the carbonate precursor. Examples of suitable molecular weight regulators are monohydric phenols such as phenol, chroman-I, paratertiarybutylphenol, or the like, or a combination comprising at least one of the foregoing molecular weight regulators. Exemplary water immiscible solvents include methylene chloride, 1,2-dichloroethane, chlorobenzene, toluene or the like, or a combination comprising at least one of the foregoing water immiscible solvents.

The phosgenation reactions are generally completed within a period of from about ten minutes to several hours. The reaction mixture should be agitated to enhance contact between phases and thereby promote the rate of reaction. Prior to product resin recovery, which can be achieved by techniques such as filtration, decantation and centrifugation, chloroformate end groups are normally substantially eliminated. When a phase transfer catalyst is used without a co-catalyst, the reaction mixture can be agitated for a long period of time until the presence of chloroformates can no longer be detected. Alternatively, the addition of an equivalent level of a phenolic compound, based on the level of chloroformate, can be added at the end of the reaction. The polycarbonate-polysiloxane copolymer can be a block copolymer that is optically transparent or opaque.

The polycarbonate in the blend of polycarbonate and polycarbonate-polysiloxane copolymer may be present in an amount of about 15 to about 85 weight percent (wt %), based upon the weight of the blend. In one embodiment, the polycarbonate is present in the blend in an amount of greater than or equal to about 30 wt %, based upon the weight of the blend. In another embodiment, the polycarbonate is present in the blend in an amount of greater than or equal to about 45 wt %, based upon the weight of the blend. In yet another embodiment, the polycarbonate is present in the blend in an amount of greater than or equal to about 75 wt %, based upon the weight of the blend.

The blend can be optically transparent or opaque. Exemplary blends of polycarbonate with polycarbonate-polysiloxane copolymer are commercially available from General Electric Company as EXL1414® (an opaque blend) and EXRLOO0049® (a transparent blend).

The polycarbonate-polysiloxane copolymer is present in the thermoplastic composition in an amount of about 15 to about 85 wt %, based upon the total weight of the thermoplastic composition. In one embodiment, the polycarbonate-polysiloxane copolymer is present in the thermoplastic composition in an amount of about 20 to about 80 wt %, based upon the total weight of the thermoplastic composition. In another embodiment, the polycarbonate-polysiloxane copolymer is present in the thermoplastic composition in an amount of about 30 to about 70 wt %, based upon the total weight of the thermoplastic composition.

The modified polyolefin resin can be any polyolefin to which an epoxy, a carboxyl, or an acid anhydride group is reacted. Examples of suitable polyolefins are crystalline polypropylene, crystalline propylene-ethylene block or random copolymers, low density polyethylene, high density polyethylene, linear low density polyethylene, ultra-high molecular weight polyethylene, ethylene-propylene random copolymer, ethylene-propylene-diene copolymer, or the like, or a combination comprising at least one of the foregoing polyolefins. Exemplary polyolefin resins are low density polyethylene, high density polyethylene, linear low density polyethylene, and the ultra-high molecular weight polyethylene.

The modified polyolefin resin may be any polyolefin resin described in the above to which an unsaturated monomer containing epoxy, carboxyl, or an acid anhydride group is copolymerized. Examples of suitable epoxy-containing unsaturated monomers include glycidyl methacrylate, butylglycidyl malate, butylglycidyl fumarate, propylglycidyl malate, glycidyl acrylate, N-[4-(2,3-epoxypropoxy)-3,5-dimethylbenzyl]-acrylamide, or the like, or a combination comprising at least one of the foregoing monomers. An exemplary epoxy-containing unsaturated monomer is glycidyl methacrylate and N-[4-(2,3-epoxypropoxy)-3,5-dimethylbenzyl]acrylamide in view of its price and availability.

Exemplary carboxyl-containing unsaturated monomers include acrylic acid, methacrylic acid, maleic acid, and the like. Exemplary unsaturated monomers containing an acid anhydride group are maleic anhydride, itaconic anhydride, citraconic anhydride, and the like. Among these, acrylic acid and maleic anhydride are desirable in view of their reactivity and availability.

The unsaturated monomer containing epoxy, carboxyl, or an acid anhydride group may be copolymerized with the polyolefin resin by any desired means. Exemplary means include melt kneading of the polyolefin resin and the unsaturated monomer in a twin screw extruder, a Banbury mixer, a kneader or the like in the presence or absence of a radical initiator, and copolymerization by the copresence of the monomer constituting the polyolefin with the unsaturated monomer containing epoxy, carboxyl, or acid anhydride. The content of the unsaturated monomer is about 0.01 to about 10 wt %, of the modified polyolefin resin. In one embodiment, the content of the unsaturated monomer is about 0.1 to about 5 wt %, by weight of the modified polyolefin resin. In one embodiment, the modified polyolefin resin is pre-compounded with an epsilon-amino-N-caproic acid prior to mixing with the blend of the polycarbonate resin and the polycarbonate-polysiloxane copolymer.

The content of the modified polyolefin resin is about 0.5 to 60 wt %, of the thermoplastic composition. In one embodiment, the content of the modified polyolefin resin is about 1 to 30 wt %, of the thermoplastic composition. In another embodiment, the content of the modified polyolefin resin is about 2 to 20 wt %, of the thermoplastic composition.

When the modified polyolefin is mixed with the blend comprising polycarbonate and polycarbonate-polysiloxane copolymer, the functionalized group covalently bonds to the polycarbonate. An exemplary modified polyethylene is commercially available from DuPont is FUSABOND®.

The thermoplastic composition can also contain optional additives such as fibrous fillers, mineral fillers, antioxidants, lubricants, surfactants, antistatic agents, flow control agents, flow promoters, impact modifiers, nucleating agents, coupling agents, flame retardants, and the like. Similarly, addition of pigments and dyes (inorganic and organic) may also be used.

As used herein, “fibrous” fillers may therefore exist in the form of whiskers, needles, rods, tubes, strands, elongated platelets, lamellar platelets, ellipsoids, micro fibers, nanofibers and nanotubes, elongated fullerenes, and the like. Where such fillers exist in aggregate form, an aggregate having an aspect ratio greater than 1 will also suffice for the purpose of this invention. Non-limiting examples of suitable fibrous fillers include short inorganic fibers, including processed mineral fibers such as those derived from blends comprising at least one of aluminum silicates, aluminum oxides, magnesium oxides, and calcium sulfate hemihydrate, boron fibers, ceramic fibers such as silicon carbide, and fibers from mixed oxides of aluminum, boron and silicon sold under the trade name NEXTEL® by 3M Co., St. Paul, Minn., USA. Also included among fibrous fillers are single crystal fibers or “whiskers” including silicon carbide, alumina, boron carbide, iron, nickel, copper. Fibrous fillers such as glass fibers, basalt fibers, including textile glass fibers and quartz may also be included.

Also included are natural organic fibers including wood flour obtained by pulverizing wood, and fibrous products such as cellulose, cotton, sisal, jute, cloth, hemp cloth, felt, and natural cellulosic fabrics such as Kraft paper, cotton paper and glass fiber containing paper, starch, cork flour, lignin, ground nut shells, corn, rice grain husks, or the like, or a combination comprising at least one of the foregoing.

In addition, organic reinforcing fibrous fillers and synthetic reinforcing fibers may be used. This includes organic polymers capable of forming fibers such as polyethylene terephthalate, polybutylene, terephthalate and other polyesters, polyarylates, polyethylene, polyvinylalcohol, polytetrafluoroethylene, acrylic resins, high tenacity fibers with high thermal stability including aromatic polyamides, polyaramid fibers such as those commercially available from DuPont under the trade name KEVLAR®, polybenzimidazole, polyimide fibers such as those available from Dow Chemical Co. under the trade names POLYIMIDE 2080® and PBZ® fiber, polyphenylene sulfide, polyether ether ketone, polyimide, polybenzoxazole, aromatic polyimides or polyetherimides, and the like. Combinations of any of the foregoing fibers may also be used.

Such reinforcing fillers may be provided in the form of monofilament or multifilament fibers and can be used either alone or in combination with other types of fiber, through, for example, co-weaving,or core/sheath, side-by-side, orange-type or matrix and fibril constructions, or by other methods of fiber manufacture. Cowoven structures generally include glass fiber-carbon fiber, carbon fiber-aromatic polyimide (aramid) fiber, and aromatic polyimide fiber-glass fiber. Fibrous fillers may be supplied in the form of, for example, rovings, woven fibrous reinforcements, such as 0-90 degree fabrics, non-woven fibrous reinforcements such as continuous strand mat, chopped strand mat, tissues, papers and felts and 3-dimensionally woven reinforcements, performs and braids.

Useful glass fibers can generally be formed from a fiberizable glass including those fiberizable glasses referred to as “E-glass,” “A-glass,” “C-glass,” “D-glass,” “R-glass,” and “S-glass”. Glass fibers obtained from E-glass derivatives may also be used. Most reinforcement mats comprise glass fibers formed from E-glass and are included in the thermoplastic compositions. Commercially produced glass fibers generally having nominal filament diameters of greater than or equal to about 8 micrometers can be used in the thermoplastic compositions. It is desirable to use glass fibers having filament diameters of less than or equal to about 35 micrometers. In one embodiment, it is desirable to use glass fibers having filament diameters having diameters of less than or equal to about 15 micrometers.

The filaments may be produced by steam or air blowing, flame blowing, and mechanical pulling processes. Exemplary filaments are made by mechanical pulling. Fibers having an asymmetrical cross section may also be used in the thermoplastic composition. The glass fibers may also be sized or unsized. Sized glass fibers are coated on at least a portion of their surfaces with a sizing composition selected for compatibility with the thermoplastic polymers. The sizing composition facilitates wet-out and wet-through of the matrix material upon the fiber strands and assists in attaining desired physical properties in the thermoplastic composition.

In one embodiment, the glass fibers comprise glass strands that have been sized. In preparing the sized glass fibers, a number of filaments can be formed simultaneously, sized with a coating agent and then bundled into what is called a strand. Alternatively the strand itself may, be first formed of filaments and then sized. The amount of sizing employed is generally an amount effective to bind the glass filaments into a continuous strand and is generally greater than or equal to about 0.1 wt % based on the total weight of the glass fibers in the strand. In one embodiment, the amount of sizing is less than or equal to about 5 wt %, based upon the weight of the glass fibers. In another embodiment, the amount of sizing is less than or equal to about 2 wt %, based upon the weight of glass fibers. In yet another embodiment the amount of sizing is about 1 wt %, based on the weight of the glass fibers.

In general, the amount of fibrous filler present in the thermoplastic composition can be up to about 50 wt %. In one embodiment, the amount of fibrous filler present in the thermoplastic composition can be up to about 20 wt %.

Carbon nanotubes that can be used in the composition are single wall carbon nanotubes (SWNTs), multiwall carbon nanotubes (MWNTs), or vapor grown carbon fibers (VGCF). Single wall carbon nanotubes (SWNTs) used in the composition may be produced by laser-evaporation of graphite, carbon arc synthesis or a high-pressure carbon monoxide conversion process (HIPCO) process. These SWNTs generally have a single wall comprising a graphene sheet with outer diameters of about 0.7 to about 2.4 nanometers (nm). The SWNTs may comprise a mixture of metallic SWNTs and semi-conducting SWNTs. Metallic SWNTs are those that display electrical characteristics similar to metals, while the semi-conducting SWNTs are those that are electrically semi-conducting. In order to minimize the quantity of SWNTs utilized in the composition, it is generally desirable to have the composition comprise as large a fraction of metallic SWNTs as possible. SWNTs having aspect ratios of greater than or equal to about 5 are generally utilized in the compositions. While the SWNTs are generally closed structures having hemispherical caps at each end of the respective tubes, it is envisioned that SWNTs having a single open end or both open ends may also be used. The SWNTs generally comprise a central portion, which is hollow, but may be filled with amorphous carbon.

MWNTs derived from processes such as laser ablation and carbon arc synthesis, may also be used in the compositions. MWNTs have at least two graphene layers bound around an inner hollow core. Hemispherical caps generally close both ends of the MWNTs, but it may desirable to use MWNTs having only one hemispherical cap or MWNTs, which are devoid of both caps. MWNTs generally have diameters of about 2 to about 50 nm. When MWNTs are used, it is desirable to have an average aspect ratio greater than or equal to about 5. In one embodiment, the aspect ratio of the MWNTs is greater than or equal to about 100, while in another embodiment, the aspect ratio of the MWNTs is greater than or equal to about 1000.

Vapor grown carbon fibers (VGCF) may also be used in the composition. These are generally manufactured in a chemical vapor deposition process. VGCF having “tree-ring” or “fishbone” structures may be grown from hydrocarbons in the vapor phase, in the presence of particulate metal catalysts at moderate temperatures, i.e., about 800 to about 1500° C. In the “tree-ring” structure a multiplicity of substantially graphitic sheets are coaxially arranged about the core. In the “fishbone” structure the fibers are characterized by graphite layers extending from the axis of the hollow core.

VGCF having diameters of about 3.5 to about 2000 nanometers (nm) and aspect ratios greater than or equal to about 5 may be used. When VGCF are used, diameters of about 3.5 to about 500 nm are desirable, with diameters of about 3.5 to about 100 nm being more desirable, and diameters of about 3.5 to about 50 nm being most desirable. It is also desirable for the VGCF to have average aspect ratios greater than or equal to about 100. In one embodiment, the VGCF can have aspect ratios greater than or equal to about 1000.

Carbon nanotubes are generally used in amounts of about 0.001 to about 80 wt % of the total weight of the thermoplastic composition when desirable. In one embodiment, carbon nanotubes are generally used in amounts of about 0.25 wt % to about 30 wt %, based on the weight of the thermoplastic composition. In another embodiment, carbon nanotubes are generally used in amounts of about 0.5 wt % to about 10 wt %, based on the weight of the thermoplastic composition. In yet another embodiment, carbon nanotubes are generally used in amounts of about 1 wt % to about 5 wt %, based on the weight of the thermoplastic composition.

Various types of conductive carbon fibers may also be used in the composition. Carbon fibers are generally classified according to their diameter, morphology, and degree of graphitization (morphology and degree of graphitization being interrelated). These characteristics are presently determined by the method used to synthesize the carbon fiber. For example, carbon fibers having diameters down to about 5 micrometers, and graphene ribbons parallel to the fiber axis (in radial, planar, or circumferential arrangements) are produced commercially by pyrolysis of organic precursors in fibrous form, including phenolics, polyacrylonitrile (PAN), or pitch.

The carbon fibers generally have a diameter of greater than or equal to about 1,000 nanometers (1 micrometer) to about 30 micrometers. In one embodiment, the fibers can have a diameter of about 2 to about 10 micrometers. In another embodiment, the fibers can have a diameter of about 3 to about 8 micrometers.

In one embodiment, in one method of manufacturing the wear resistant composition, an anhydride-modified polyolefin is mixed with a blend comprising polycarbonate and polycarbonate-polysiloxane copolymer. The blending can be conducted in solution or in the melt. An exemplary form of blending is melt blending.

Melt blending of the composition involves the use of shear force, extensional force, compressive force, ultrasonic energy, electromagnetic energy, thermal energy or combinations comprising at least one of the foregoing forces or forms of energy and is conducted in processing equipment wherein the aforementioned forces are exerted by a single screw, multiple screws, intermeshing co-rotating or counter rotating screws, non-intermeshing co-rotating or counter rotating screws, reciprocating screws, screws with pins, barrels with pins, rolls, rams, helical rotors, or combinations comprising at least one of the foregoing.

Melt blending involving the aforementioned forces may be conducted in machines such as, single or multiple screw extruders, Buss kneader, Henschel, helicones, Ross mixer, Banbury, roll mills, molding machines such as injection molding machines, vacuum forming machines, blow molding machine, or then like, or combinations comprising at least one of the foregoing machines. It is generally desirable during melt or solution blending of the composition to impart a specific energy of about 0.01 to about 10 kilowatt-hour/kilogram (kwhr/kg) of the composition.

The thermoplastic compositions can be manufactured by a number of methods. In one exemplary process, the thermoplastic polymers, the glass fibers, and additional ingredients are compounded in an extruder and extruded to produce pellets. During the extrusion, the anhydride-modified polyolefin, the blend of polycarbonate with polycarbonate-polysiloxane copolymer and other optional ingredients are mixed with each other under shear. The extrudate is pelletized and then injection molded to form a wear resistant article. In another exemplary process, the thermoplastic composition can also be mixed in a dry blending process (e.g., in a Henschel mixer) and directly molded, e.g., by injection molding or any other suitable transfer molding technique. It is desirable to have all of the components of the thermoplastic composition free from water prior to extrusion and/or molding.

In another exemplary method of manufacturing the thermoplastic composition, the optional fibrous fillers can be masterbatched into the blend of the polycarbonate with the polycarbonate-polysiloxane copolymer. The masterbatch may then be let down with additional polymer that comprises the modified polyolefin during the extrusion process or during a molding process to form the wear resistant thermoplastic composition.

Exemplary extrusion temperatures are about 260 to about 310° C. The compounded thermoplastic composition can be extruded into granules or pellets, cut into sheets or shaped into briquettes for further downstream processing. The composition can then be molded in equipment generally employed for processing thermoplastic compositions, e.g., an injection molding machine with cylinder temperatures of about 250 to about 300° C., and mold temperatures of about 50 to about 90° C.

Wear resistant thermoplastic compositions thus obtained display a number of advantageous properties over other available wear resistant compositions. The wear resistant thermoplastic compositions of the present disclosure display a useful combination of high impact strength as well as a low wear factor. The wear resistant thermoplastic composition displays a notched Izod impact strength of greater than or equal to about 500 joules/meter at, −30° C. In another embodiment, the wear resistant thermoplastic composition displays a notched Izod impact strength of greater than or equal to about 650 joules/meter at −30° C. In yet another embodiment, the wear resistant thermoplastic composition displays a notched Izod impact strength of greater than or equal to about 700 joules/meter at −30° C.

The wear resistant thermoplastic composition also displays a wear factor K of less than or equal to about 350 in⁵min/ftlb-hr. The wear factor is based upon the weight lost during the test. In one embodiment, the wear factor K is less than or equal to about 200 in⁵min/ftlb-hr. In another embodiment, the wear factor K is less than or equal to about 100 in⁵min/ftlb-hr. In another embodiment, the wear factor K is less than or equal to about 80 in⁵min/ftlb-hr. in yet another embodiment, the wear factor K is less than or equal to about 60 in⁵min/ftlb-hr.

The wear resistant thermoplastic compositions can be molded to have a smooth surface finish. In one embodiment, the thermoplastic compositions can have a Class A surface finish. When the thermoplastic composition comprises electrically conductive fibrous fillers (e.g., carbon fibers, carbon nanotubes, carbon black, or combinations thereof) articles molded from the composition can have an electrical volume resistivity of less than of equal to about 10¹² ohm-cm. In one embodiment, the thermoplastic composition can have an electrical volume resistivity of less than of equal to about 10⁸ ohm-cm. In another embodiment, the composition can have an electrical volume resistivity of less than of equal to about 10⁵ ohm-cm. The thermoplastic composition can also have a surface resistivity of less than or equal to about 10¹² ohm per square centimeter. In one embodiment, the thermoplastic composition can also have a surface resistivity of less than or equal to about 10⁸ ohm per square centimeter. In another embodiment, the thermoplastic composition can also have a surface resistivity of less than or equal to about 10⁴ ohm per square centimeter.

The composition is also flame retardant. In one embodiment, the composition can have a UL-94 (Underwriters Laboratories) flame retardancy rating of V-0. In another embodiment, the composition can have a UL-94 flame retardancy rating of V-1. In another embodiment, the composition can have a UL-94 flame retardancy rating of V-2. The composition displays a heat distortion temperature (HDT) of greater than or equal to about 100° C. In one embodiment, the composition displays a heat distortion temperature (HDT) of greater than or equal to about 120° C.

The wear resistant thermoplastic compositions can be manufactured into articles that are subjected to high temperature applications where large dynamic loads are applied. They can be advantageously used in automotive applications or in machines as gears, cams, bearings, or as components where increased impact strength, wear resistance and high crack propagation resistance are desirable.

The following examples, which are meant to be exemplary, not limiting, illustrate compositions and methods for manufacturing the wear resistant thermoplastic compositions described herein.

### EXAMPLES

This example demonstrates the advantageous wear resistance and the impact properties of a thermoplastic composition comprising polycarbonate, polycarbonate-polysiloxane copolymer and anhydride-modified polyethylene. Two blends of polycarbonate with polycarbonate-polysiloxane copolymer were used. They were EXRL0049®, a transparent blend containing 17 wt % polycarbonate with 83 wt % polycarbonate-polysiloxane copolymer and EXL1414® an opaque blend of 82.5 wt % polycarbonate with 17.5 wt % polycarbonate-polysiloxane copolymer. The respective blends were mixed with a LUBRILOY D EP® intermediate manufactured by LNP as detailed below.

71.600 parts per hundred (phr) of FUSABOND MB226D®, a maleic anhydride modified polyethylene commercially available from DuPont was pre-compounded with 3.4 phr of A2504, an epsilon-amino-N-caproic acid commercially available from Sigma Chemicals. The precompounding was conducted in a twin screw extruder. To the precompound was added 25 phr of additional FUSABOND MB226D®. The additional FUSABOND MB226D® was mixed with the precompound in a twin screw extruder to form the LUBRILOY D EP® intermediate. The extrusion is carried out at a temperature of 240° C. The respective wear resistant thermoplastic compositions are shown in the Table 1.

The respective components for the samples in Table 1 were extruded in a 37 mm twin-screw extruder (ZSK-40®) manufactured by Krupp, Werner and Pfleiderer. The twin screw extruder had a length to diameter ratio of 41. Table 1 shows the wear resistant compositions obtained when the LUBRILOY D EP® intermediate was extruded with either EXL1414® or with EXRL0049®. Samples #1 and #2 in Table 1 are comparative compositions comprising only the blend of polycarbonate with the polycarbonate-polysiloxane copolymer.

The compositions in Table 1 were extruded under the following conditions. The extruder had 11 barrels or heating zones set at temperatures of 50° C., 100° C., 250° C., 290° C., 290° C., 290° C., 290° C., 290° C., 290° C., 290° C. and 290° C. The die temperature was set at 270° C. The extruder was run at 300 rpm. The extruder can be run at speeds of 30 to 300 rpm. The extrusion rate was 30 kilograms per hour but greater extrusion rates can also be used. The strand emanating from the extruder was pelletized, dried and subjected to injection molding to manufacture the test parts. The molding machine was a Cincinnati 220T. The amounts of each component employed in the various compositions are shown in Tables 1. All components were added directly in the extruder during extrusion.

Following extrusion and injection molding, the samples were subjected to testing. Tensile testing was conducted as per ASTM D 638. Impact testing was conducted as per ASTM D 256. Flexural testing was conducted as per ASTM D 790. The heat distortion temperature (HDT) test was conducted using a distortion force of 1.84 MPa on samples having a thickness of 3.2 millimeters. Melt flow rate (MFR) was conducted at 300° C. using a shearing force of 1.2 kilograms.

The wear factor K was measured as per WI-0687 (which is a modified wear testing method and is similar to ASTM D 3702-78). The standard test is conducted by rotating a plastic thrust washer, at a specified speed and under a constant pressure, against a steel wear ring counterface, which is held stationary. Variations of the standard test include using alternate counterface materials, alternate counterface surface finishes and testing at elevated temperatures. The applied pressure (psi) and speed (feet per minute (fpm)) condition, when multiplied together, is known as the PV (pressure-velocity) value for the test. The test is conducted by running the thrust washer test specimen approximately 24 hours under the specified PV conditions, then removing the specimen and measuring weight loss. From this weight loss value a wear factor (K) can be calculated using following formula:
Wear Factor=[(6.1×10⁸)(W)]/[(P×V)×(D)×(T)]
where W is the weight loss in grams, D is the density in grams per cubic centimeter, T is the time in hours. The applied pressure P is 40 psi while the velocity is 50 fpm.

This procedure is repeated for approximately 100 hours and the wear factors for each interval are averaged to yield an average wear factor (K) for the material. Additionally, static and dynamic coefficients of friction (COF) are measured for each interval. These COF values are averaged over the length of the test to yield an average static and dynamic coefficient of friction for the material. All test results are shown in Table 1.

TABLE 1

| Composition | #1 | #2 | #3 | #4 | #5 | #6 |
|---|---|---|---|---|---|---|
| EXL1414 ® (wt %) | 100 | | 96 | 95 | — | — |
| EXRL0049 ® (wt %) | — | 100 | — | — | 96 | 95 |
| LUBRILOY ® intermediate (wt %) | 0 | 0 | 4 | 5 | 4 | 5 |
| Properties | | | | | | |
| Melt Flow Rate (g/10 min) | 10.7 | 10 | 14.4 | 15.1 | 12.3 | 12.7 |
| HDT (° C.) | 122 | 121 | 119 | 118 | 123 | 122 |
| Notched Izod @ Room Temperature (J/M) | 877 | 764 | 704 | 699 | 715 | 670 |
| Notched Izod @ −30° C. (J/M) | 777 | 748 | 651 | 640 | 526 | 506 |
| Tensile strength (MPa) | 55.6 | 59 | 50.6 | 49.9 | 50.1 | 53.5 |
| Tensile elongation @ yield (%) | 6.1 | 6.0 | 5.9 | 5.9 | 5.7 | 5.7 |
| Tensile elongation @ break (%) | 110 | 127 | 105 | 100 | 120 | 120 |
| Flexural Modulus (MPa) | 2060 | 2220 | 1920 | 1900 | 1780 | 1750 |
| Flexural Strength (MPa) | 84.1 | 92 | 75.2 | 75.4 | 70.2 | 69.4 |
| Weak Factor K (in³ min/ft lb-hr) | 4236 | 3892 | 329 | 143 | 56 | 23 |

From the Table 1 it may be seen that the wear resistant thermoplastic compositions are far superior to the blend of polycarbonate resin with polycarbonate-polysiloxane copolymer. Similarly, it may be seen that when the transparent blend is combined with the modified polyethylene, the wear properties are superior to the corresponding properties for a combination of the opaque blend with the modified polyethylene.

Without being limited by theory, it is believed that the smaller and uniform distribution of polysiloxane domain sizes and the uniform distribution of interdomain spacings in the transparent blend facilitate a controlled interaction between the polycarbonate and the modified polyethylene. This controlled interaction produces superior wear properties. Despite, the improved results for the thermoplastic composition comprising the transparent blend, it can be seen that the thermoplastic composition comprising the opaque blend also has a unique combination of wear resistance and impact resistance.

The wear resistant compositions can be advantageously used in gears, cams, bearings, sliding surfaces, and the like, where a combination or wear resistance, impact resistance and optional features such as electrical conductivity and flame retardancy are desired.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A composition comprising:
a polycarbonate resin;
a polycarbonate-polysiloxane copolymer; and
a modified polyolefin.

2. The composition of claim 1, wherein the composition has a weight loss wear factor of less than or equal to about 350 in⁵min/ftlb-hr and a notched Izod impact strength of greater than or equal to about 500 joules per meter at −30° C. and wherein the wear factor is measured according to the formula:
Wear Factor=[(6.1×10⁸)(W)]/[(P×V)×(D)×(T)]
where P is the applied pressure in pounds per square inch and V is the velocity in feet per minute, W is the weight loss in grams, D is the density in grams per cubic centimeter and T represents 100 hours.

3. The composition of claim 2, wherein the composition has a weight loss wear factor of less than or equal to about 100 in⁵min/ftlb-hr and a notched Izod impact strength of greater than or equal to about 500 joules per meter at -30° C.

4. The composition of claim 1, wherein the composition has a Class A surface finish when molded.

5. The composition of claim 1, wherein the composition has a tensile strength of greater than or equal to about 50 MPa and a heat distortion temperature of greater than or equal to about 100° C.

6. The composition of claim 1, wherein the composition has a bulk volume resistivity of less than or equal to about 10¹² ohm-cm.

7. The composition of claim 1, wherein the composition has a flammability rating of V-2, V-1 or V-0 in UL-94 flame retardancy test.

8. The composition of claim 1, comprising about 15 to about 85 weight percent polycarbonate resin, based upon the weight of the blend.

9. The composition of claim 1, wherein the blend of polycarbonate resin with the polycarbonate-polysiloxane copolymer is optically transparent.

10. The composition of claim 1, wherein the modified polyolefin comprises about 0.01 to about 10 wt % of epoxy, carboxyl or acid anhydride functionalities, based on the total weight of the modified polyolefin and wherein the modified polyolefin further comprises an epsilon-amino-N-caproic acid.

11. The composition of claim 1, comprising about 0.5 to about 60 weight percent of the modified polyolefin, based upon the total weight of the thermoplastic composition.

12. The composition of claim 1, wherein the polyolefins are crystalline polypropylene, crystalline propylene-ethylene block or random copolymers, low density polyethylene, high density polyethylene, linear low density polyethylene, ultra-high molecular weight polyethylene, ethylene-propylene random copolymer, ethylene-propylene-diene copolymer, or a combination comprising at least one of the foregoing polyolefins.

13. The composition of claim 1, further comprising fibrous fillers.

14. The composition of claim 13, wherein the fibrous fillers are glass fibers, polymeric fibers, carbon nanotubes, carbon fibers, or a combination comprising at least one of the foregoing fibers.

15. A composition comprising:
a blend of a polycarbonate resin with a polycarbonate-polysiloxane copolymer; and
a modified polyethylene, wherein the composition has a wear factor of less than or equal to about 350 in⁵min/ftlb-hr and an impact strength of greater than or equal to about 500 joules per meter, and wherein the wear factor is measured according to the formula:
Wear Factor=[(6.1×10⁸)(W)]/[(P×V)×(D)×(T)]
where P is the applied pressure in pounds per square inch and V is the velocity in feet per minute, W is the weight loss in grams, D is the density in grams per cubic centimeter and T represents 100 hours.

16. The composition of claim 15, wherein the composition has a wear factor of less than or equal to about 100 in⁵min/ftlb-hr and a notched Izod impact strength of greater than or equal to about 500 joules per meter at −30° C.

17. The composition of claim 15, wherein the composition has a Class A surface finish when molded.

18. The composition of claim 15, wherein the composition has a tensile strength of greater than or equal to about 50 MPa and a heat distortion temperature of greater than or equal to about 100° C.

19. The composition of claim 15, wherein the modified polyolefin comprises about 0.01 to about 10 wt % of epoxy, carboxyl, or acid anhydride functional groups, based on the total weight of the modified polyolefin.

20. The composition of claim 19, wherein the modified polyolefin further comprises an epsilon-amino-N-caproic acid.

21. The composition of claim 15, comprising about 0.5 to about 60 weight percent of the modified polyolefin, based upon the total weight of the thermoplastic composition.

22. The composition of claim 15, wherein the polyolefin is a crystalline polypropylene, a crystalline propylene-ethylene block or random copolymer, a low density polyethylene, a high density polyethylene, a linear low density polyethylene, an ultra-high molecular weight polyethylene, an ethylene-propylene random copolymer, an ethylene-propylene-diene copolymer, or a combination comprising at least one of the foregoing polyolefins.

23. A method comprising:
blending a polycarbonate resin, a polycarbonate-polysiloxane copolymer, and a modified polyolefin to form a thermoplastic composition, wherein a blend of the polycarbonate resin and the polycarbonate-polysiloxane copolymer is either optically transparent or opaque.

24. The method of claim 23, wherein the blending is melt blending or solution blending.

25. The method of claim 23, wherein the blending involves the use of shear force, extensional force, compressive force, ultrasonic energy, electromagnetic energy, thermal energy or combinations comprising at least one of the foregoing forces or forms of energy and is conducted in processing equipment wherein the aforementioned forces are exerted by a single screw, multiple screws, intermeshing co-rotating or counter rotating screws, non-intermeshing co-rotating or counter rotating screws, reciprocating screws, screws with pins, barrels with pins, rolls, rams, helical rotors, or combinations comprising at least one of the foregoing.

26. The method of claim 23, wherein the blending is conducted in a single or multiple screw extruder, Buss kneader, Henschel, helicones, Ross mixer, Banbury, roll mills, molding machines, injection molding machines, vacuum forming machines, blow molding machine, or combinations comprising at least one of the foregoing machines.

27. The method of claim 23, further comprising molding the composition.

28. The method of claim 27, wherein the molding comprises injection molding.

29. An article comprising the composition of claim 1.

30. An article comprising the composition of claim 15.

31. An article manufactured by the method of claim 23.
